(19) United States
(12) Patent Application Publication
(10) Pub. No.: US 2015/0308083 A1
(43) Pub. Date: Oct. 29, 2015

(54) VERTICAL INDICATOR POST WITH TORQUE-REDUCING GEARING

(71) Applicant: Weilong Valve Company, Ltd., Qingdao (CN)

(72) Inventors: Fan Qingwei, Qingdao (CN); Zhang Huiting, Qingdao (CN)

(73) Assignee: Weilong Valve Company, Ltd., Qingdao (CN)

(21) Appl. No.: 14/261,857

(22) Filed: Apr. 25, 2014

(51) Int. Cl. E03B 7/07; F16K 31/44; F16K 37/00; F16K 3/30; A62C 35/68; E03B 7/09

(52) U.S. Cl. CPC E03B 7/075; A62C 35/68; E03B 7/095; F16K 37/0058; F16K 3/30; F16K 31/44

(57) ABSTRACT

An indicator post that requires less torque for operating a valve includes an elongated housing having opposite first and second ends. A gear housing is located at the housing second end and is configured to secure the indicator post to the body of a valve. An operating member is located at the housing first end and is rotatable in relation to the housing. An elongated stem is located within the housing and has a first end connected to the operating member and an opposite second end. The indicator post also includes a coupler that is configured to rotate the stem of the valve. A gear set is positioned within the gear housing and includes a plurality of gears that are arranged to produce an output torque on the coupler that is greater than an input torque from the stem.

### FIELD OF THE INVENTION

The present invention relates generally to valves and, more particularly, to apparatus for actuating valves.

### BACKGROUND OF THE INVENTION

Vertical indicator posts are used in outside fire protection loops or piping systems that go around buildings and feed water to fire protection systems (i.e., sprinkler systems) inside of buildings. The water for these sprinkler systems is typically drawn off a municipal water main and routed to the building corners, where “risers” bring it up into the building, or it is routed to a “pit” where fire hoses can be attached (outside the building). Gate valves typically are used to control the flow of water into a fire protection system from a water main, and a vertical indicator post typically is attached to the gate valve and used to operate the gate valve. These gate valves are typically located below ground and the vertical indicator post extends from the valve up through the ground.

FIGS. 1-2 illustrate an exemplary gate valve 10 that may be used in fire protection loops/piping systems. The gate valve 10 includes a valve casing or body 12 having a through-bore 14 for the passage of fluid therethrough and a chamber 16 intersecting the through-bore 14 and defining ports 18 and 20. The ports 18 and 20 may be inlet or outlet ports to the chamber 16, depending upon which way the gate valve 10 is inserted into a piping system.

The chamber 16 includes a wedge or gate 22 that is raised and lowered within the chamber 16 to control flow of fluid (e.g., water) through the gate valve 10 via rotation of a stem 24. A bonnet 26 having a post flange 28 is attached to the top of the valve body 12. A valve stem 24 for raising and lowering the gate 22 extends through the bonnet 26 and flange 28, and an operating nut 30 is positioned on and secured to the distal end 24a of the valve stem 24.

Referring now to FIG. 3, a conventional vertical indicator post 40 for operating an underground gate valve, such as the gate valve 10 of FIGS. 1-2, is illustrated. The vertical indicator post 40 includes an outer generally cylindrical housing 42 which is configured to be connected at its lower end 42a to a gate valve. For example, the lower end 42a is configured to be attached to the bonnet post flange 28 of the gate valve 10 of FIGS. 1-2.

An elongated stem 44 within the indicator post body 42 includes opposite upper and lower portions 44a, 44b. The stem lower portion 44b is attached to a coupler 46, for example, via a pin 48. Coupler 46 is configured to fit over and engage the gate valve operating nut 30 (FIGS. 1-2). The stem upper portion 44a is attached to an operating nut 50. A wrench 52 is shown in FIG. 3 in a locked position such that the gate of a gate valve connected to the indicator post 40 cannot be moved. In operation, the wrench is removed from the indicator post 40 and a socket 54 of the wrench 52 is engaged with the operating nut 50. Rotation of the wrench 52 causes rotation of the operating nut 50 and stem 44 to open/close the gate of a gate valve attached to the indicator post 40.

Large gate valves (i.e., 14″-24″) may be difficult to operate via conventional indicator posts by a single person due to the large amount of torque required. In addition, when a gate valve is closed at extreme high temperatures and then cooled, the gate may become tight in the valve and may be difficult to open, particularly for large gate valves. Similarly, a gate valve closed at room temperature may be difficult to open if there is an increase in fluid temperature causing a linear expansion of the stem, which may tighten the wedge further into the body seat.

To reduce the required torque to operate large gate valves such that one person can open and close the valve, some valve manufacturers have added a “spur gear” mechanism to the valve. Unfortunately, such spur mechanisms increase the cost and complexity of gate valves.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, an indicator post that requires less torque for operating a valve stem of a valve includes an elongated, substantially cylindrical housing having opposite first and second ends. A gear housing is located at the indicator post housing second end and is configured to secure the indicator post to the body of a valve. An operating member is located at the indicator post housing first end and is rotatable in relation to the indicator post housing. A stem is located within the indicator post housing and has a first end connected to the operating member and an opposite second end. The indicator post also includes a coupler that is configured to rotate the stem of a valve attached to the indicator post. In some embodiments, a cap is secured to and covers the indicator post housing first end, and the operating member extends through the cap. The operating member is a nut that is configured to be engaged and rotated by a user via a wrench.

The indicator post housing includes a window that provides an exterior view into the indicator post housing. An indicator assembly is located within the indicator post housing and includes targets that are indicative of the operating position of a valve. The indicator assembly is connected to the operating member so as to be movable relative to the window, and such that when one of the targets is visible through the window, the other target is obstructed and cannot be viewed.

A gear set is positioned within the gear housing and is operably coupled with the stem and the coupler. The gear set includes a plurality of gears that are arranged to produce an output torque on the coupler that is greater than an input torque from the stem. For example, in some embodiments, the output torque may be greater than the input torque by a ratio of at least two to one (2:1).

In some embodiments, the gear set includes a spindle that is rotatable about a spindle axis with first and second gears fixed for rotation with the spindle in adjacent, spaced-apart relationship. The first gear has a diameter that is greater than a diameter of the second gear. A third gear is fixed for rotation with the stem, for example adjacent the stem second end, and the first gear meshes with the third gear. A fourth gear is fixed for rotation with the coupler, and the second gear meshes with the fourth gear.

Embodiments of the present invention are advantageous because, in addition to reducing torque required to operate large gate valves, the need for a spur gear attachment is eliminated. As such, the overall height of a valve and indicator post assembly according to embodiments of the present invention can be reduced, thereby allowing valves to be placed in shallower trenches. Spur gears and bevel gears associated with conventional gate valves are susceptible to ingress of foreign material and dirt. The configuration of the gear housing encasing the gear set of the present invention prevents the ingress of debris and other foreign matter into the gear set.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a perspective view of a conventional gate valve for use in outside fire protection loops or piping systems.

FIG. 2 is a perspective cut-away view of the gate valve of FIG. 1.

FIG. 3 is a side cutaway view of a conventional vertical indicator post for operating a gate valve, such as the valve of FIGS. 1-2.

FIG. 4 is a side cutaway view of a vertical indicator post for operating a gate valve, such as the valve of FIGS. 1-2, according to some embodiments of the present invention.

FIG. 5 is an enlarged, cross-sectional view of the lower end portion of the vertical indicator post of FIG. 4 illustrating the reduced-torque gearing, according to some embodiments of the present invention.

FIGS. 6-7 are side, partial cutaway views of the vertical indicator post of FIG. 4 attached to a gate valve.

### DETAILED DESCRIPTION OF THE INVENTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines may illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

As used herein, the term “and/or” includes any and all combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/−20%, 10%, 5%, 1%, 0.5%, or even 0.1%.

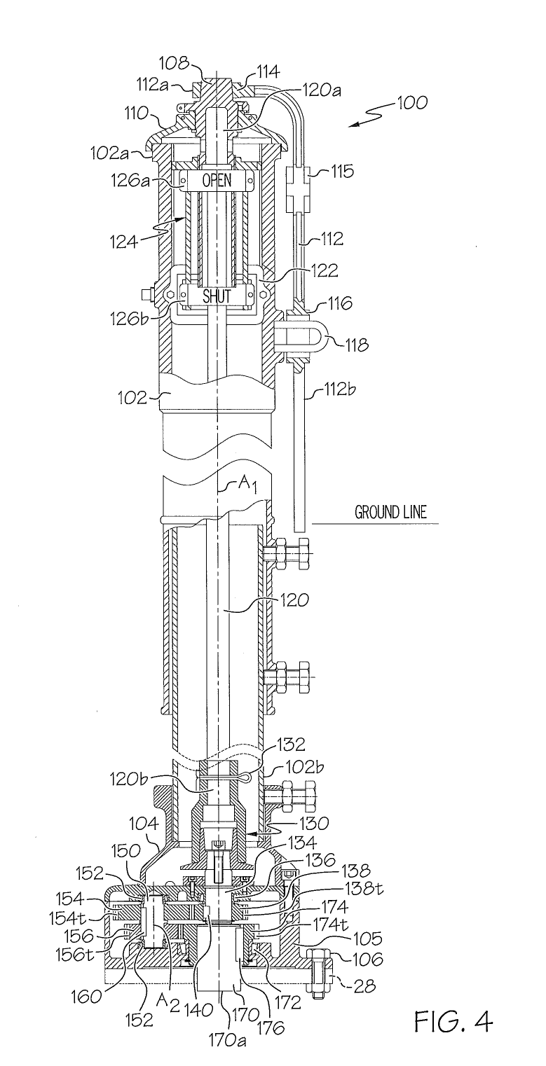

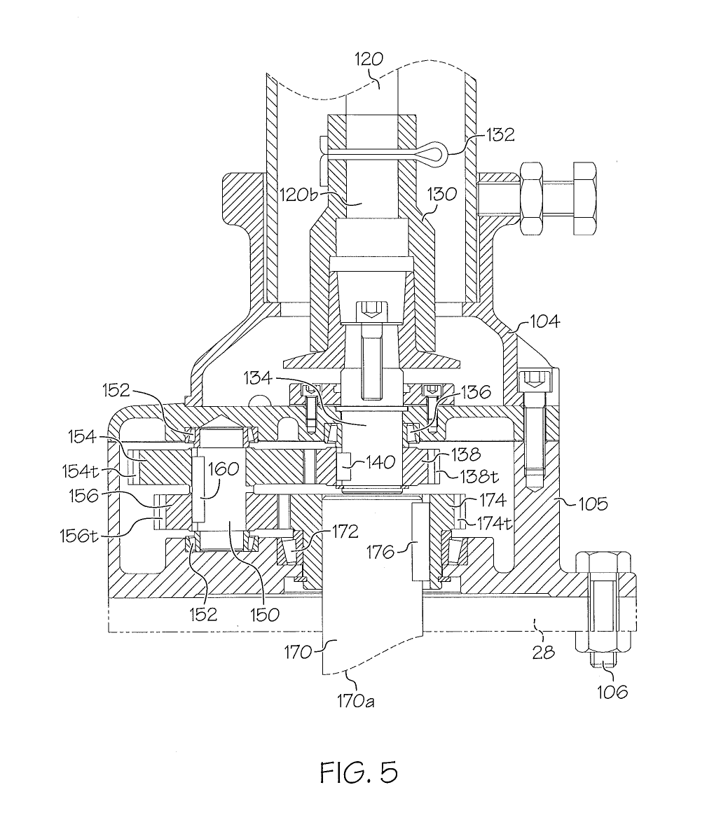

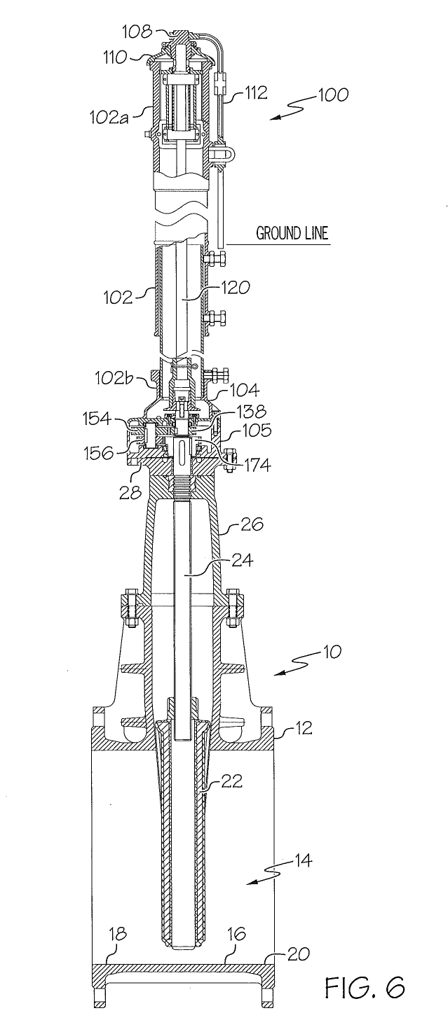

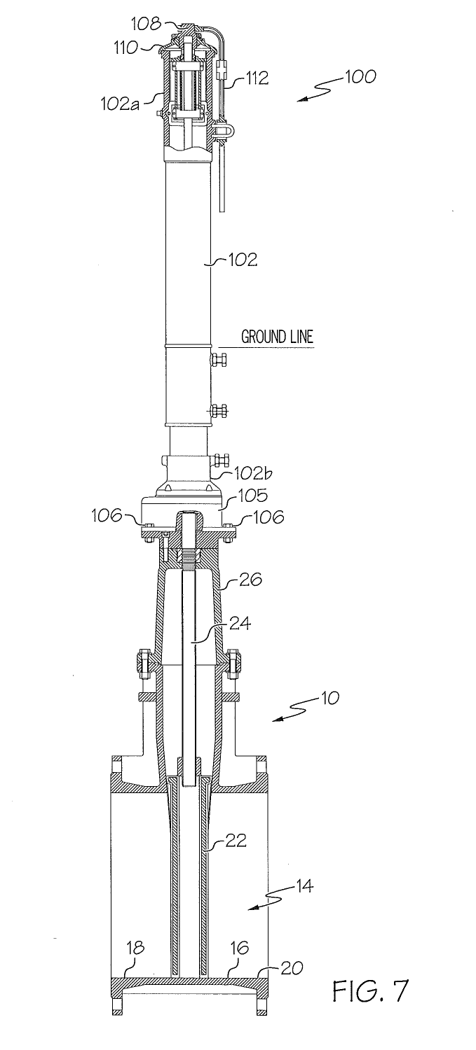

Referring now to FIG. 4, a vertical indicator post 100 according to some embodiments of the present invention that requires less torque for operating a valve stem of a valve attached thereto is illustrated. The indicator post 100 includes an elongated, substantially cylindrical housing 102 having opposite first and second ends 102a, 102b; however, other shapes are possible for the housing 102. The housing 102, may be formed from various materials, but typically is formed from cast iron.

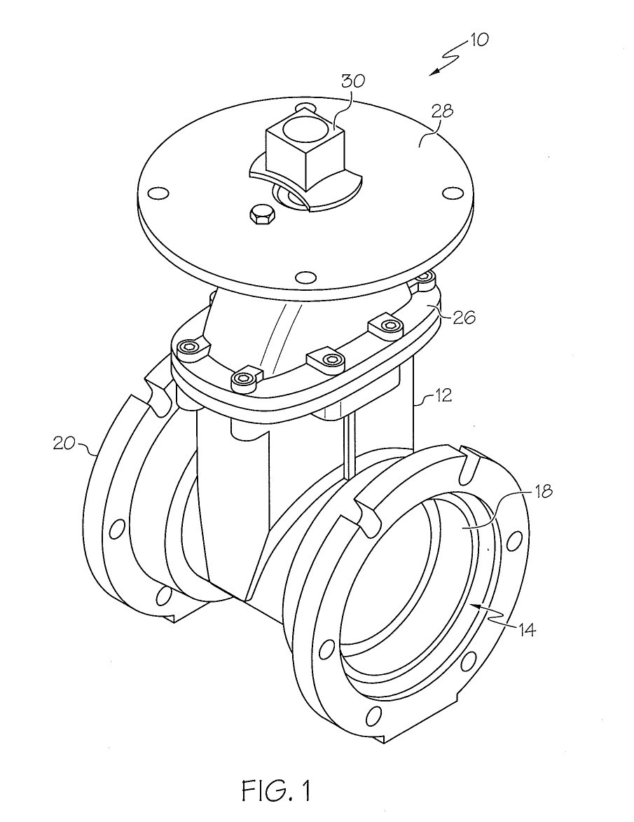

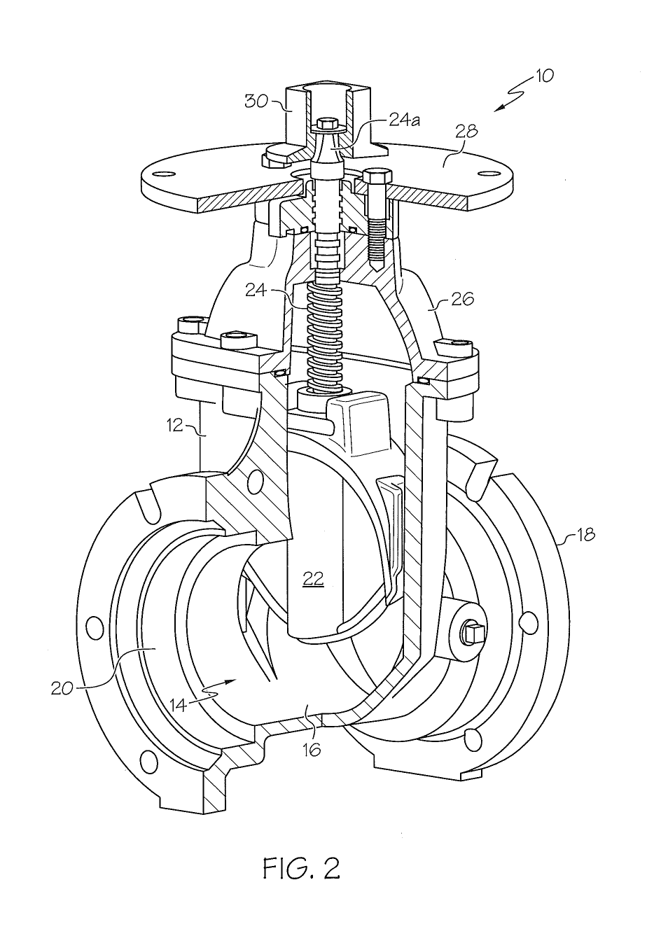

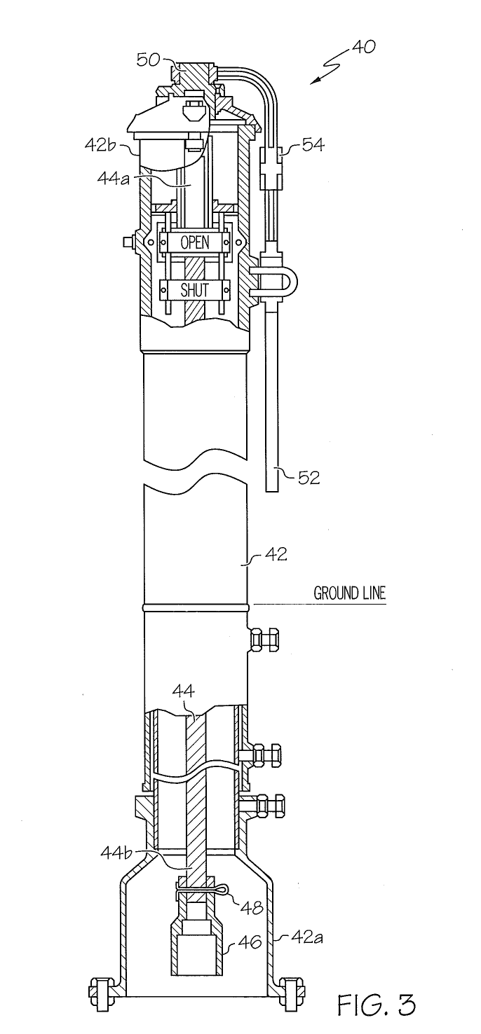

An expanded housing or “bell” 104 is attached to the housing second end 102b. A gear housing 105 is attached to the bell 104, for example via bolts, and encloses a gear set that includes first and second gears 154, 156, shaft gear 138, and coupler gear 174, as will be described below. The gear housing 105 is configured to secure the indicator post 100 to the body of a valve. For example, the gear housing 105 is configured to be secured to the bonnet flange 28 of valve 10 in FIGS. 1-2 via bolts 106, as would be understood by one skilled in the art. The bell 104 and gear housing 105 may be formed from various materials, but typically are formed from cast iron. Although not illustrated, one or more o-rings and/or gaskets may be utilized between the gear housing 105 and the bonnet flange 28 in order to seal the gear housing and prevent the ingress of water into the gear housing 105.

An operating member 108, such as a hexagonal-shaped member, is located at the housing first end 102a and is rotatable in relation to the housing. In the illustrated embodiment, a cap 110 is secured to and covers the housing first end 102a, and the operating member 108 extends through the cap 110. The operating member 108 is configured to be engaged and rotated by a user via a wrench 112. In the illustrated embodiment of FIG. 4, the wrench 112 is secured to the indicator post 100 in a stored position. The wrench 112 includes a box end 114 at a first end 112a thereof that engages the operating member such that the elongated portion 112b of the wrench 112 extends downwardly along the housing 102 and in adjacent, spaced-apart relation thereto. The wrench 112 includes a locking housing 116 in a medial portion of the elongated portion 112b that is configured to be engaged with a locking ring 118 connected to the housing 102. A lock (not shown) can be inserted through the locking ring 118 to secure the wrench to the housing 102, as would be understood by one skilled in the art. When the wrench 112 is in the illustrated position of FIG. 4, the operating member 108 cannot be rotated and, thus, a valve attached to the indicator post 100 cannot be opened or closed.

The illustrated wrench 112 also includes an operating socket 115. To operate a valve connected to the indicator post 100, a user removes the wrench 112 from the stored position illustrated in FIG. 4 and engages the operating socket 115 with the indicator post operating member 108. The wrench 112 is then used to rotate the operating member to open and close the valve, as would be understood by one skilled in the art of the present invention.

The indicator post 100 includes an elongated rod or stem 120 located within the housing 102. The stem 120 has opposite first and second ends 120a, 120b, and has a generally rectangular or square cross section; however, other shapes are possible for the elongated stem 120. The stem first end 120a is connected to the operating member 108. Thus, rotation of the operating member 108 causes rotation of the stem 120 about its axis A₁.

The illustrated housing 102 includes a window 122 that provides an exterior view into the housing 102. An indicator assembly 124 is located within the housing 102 and includes two targets 126a, 126b that are indicative of the operating position of the valve to which the indicator post 100 is attached. For example, target 126a is “OPEN” and target 126b is “SHUT”.

The indicator assembly 124 is operably associated with the stem 120. For example, the indicator assembly includes a threaded mechanism that is attached to a threaded part of the stem 120. Rotation of the stem 120 in one direction causes movement of the indicator assembly 124 in one direction, and rotation of the stem 120 in the opposite direction causes movement of the indicator assembly 124 in the opposite direction. As such, rotation of the stem 120 in one direction will move one of the targets 126a, 126b such that it is viewable in the window 122, and rotation of the stem 120 in the opposite direction will move the other one of the targets 126a, 126b such that it is viewable in the window 122. Thus, when a user rotates the operating member 108 such that the valve 10 is fully open, target 126a (“OPEN”) appears in the window 122, and the other target 126b is obstructed from view. Conversely, when a user rotates the operating member 108 in an opposite direction such that the valve 10 is fully closed, target 126b (“SHUT”) appears in the window 122, and the other target 126a is obstructed from view.

In the illustrated embodiment, the second end 120b of the stem 120 is connected to a coupling mechanism 130 via a pin 132. However, the coupling mechanism 130 may be attached to the stem second end 120b in various other ways. The coupling mechanism 130 includes a shaft 134 extending downwardly from the stem 120 and into the gear housing 105. The shaft 134 has a rotational axis that is substantially aligned with the rotational axis A₁ of the stem 120. Thus, rotation of the operating member 108 causes rotation of the shaft 134 within the gear housing 105 about rotational axis A₁. Although not illustrated, one or more o-rings may be utilized to seal the shaft 134 relative to the gear housing 105 in order to prevent the ingress of water into the gear housing 105.

A bearing 136 is positioned within the body of the gear housing 105 and the shaft 134 extends through and is rotatably supported within the gear housing 105 by the bearing 136. A gear 138 is coaxially supported on the shaft 134 and is fixed for rotation with the shaft 134 via a key 140. However, the gear 138 may be fixed for rotation with the shaft 134 in various ways (e.g., welding, fasteners, etc.) as would be understood by one skilled in the art of the present invention.

A spindle 150 is rotatably secured within the gear housing 105 adjacent to the shaft 134 via bearings 152, as illustrated in FIG. 4. The spindle 150 is rotatable about its axis A₂. A pair of first and second gears 154, 156 are coaxially supported on the spindle 150 in adjacent, spaced-apart relationship, and are fixed for rotation with the spindle 150 via a key 160. However, the first and second gears 154, 156 may be fixed for rotation with the spindle 150 in various ways (e.g., welding, fasteners, etc.) as would be understood by one skilled in the art of the present invention.

In the illustrated embodiment, the first gear 154 has a diameter that is greater than a diameter of the second gear 156. The gear teeth 154t of the first gear 154 mesh with the gear teeth 138t of the gear 138 fixedly supported on the shaft 134 so that rotation of gear 138, as a result of user rotation of the operating member 108, causes rotation of the first gear 154 about axis A₂. Because the first and second gears 154, 156 are fixed to the spindle 150, rotation of the first gear 154 thereby causes rotation of the spindle 150 and second gear 156 about axis A₂.

A coupler 170 is rotatably secured within the gear housing 105 via a bearing 172, as illustrated in FIG. 4. In some embodiments, the coupler 170 has a free end 170a with a socket configuration that is configured to be inserted over and engage the operating nut of a gate valve (e.g., operating nut 30 of valve 10, FIGS. 1-2). In other embodiments, the coupler 170 may be directly attached to a valve stem or may be a portion of the valve stem, itself. Either way, the shaft 134 and the coupler 170 are independent of each other and not directly connected except via the first and second gears 154, 156.

The coupler 170 has a rotational axis that is substantially aligned with the rotational axis A₁ of the stem 120 and the shaft 134. A gear 174 is coaxially supported on the coupler 170 and is fixed for rotation with the coupler 176 via a key 140. However, the gear 174 may be fixed for rotation with the coupler 176 in various ways (e.g., welding, fasteners, etc.) as would be understood by one skilled in the art of the present invention. In the illustrated embodiment, the bearing 172 surrounds and engages a neck portion 174a of the gear 174. However, in other embodiments, gear 174 need not include a neck portion and the bearing 172 can surround and engage the coupler 170 directly.

The gear teeth 156t of the second gear 156 mesh with the gear teeth 174t of the coupler gear 174. As such, rotation of the operating member 108 by a user causes rotation of the shaft 134 within the gear housing 105 about rotational axis A₁, which causes rotation of the spindle 150 due to the gear teeth 138t, 154t of the shaft gear 138 and the first gear 154 being meshed together, which causes rotation of the coupler 170 due to the gear teeth 156t, 174t of the second gear 156 and the coupler gear 174 being meshed together. Because the diameter of the first gear 154 is larger than the diameter of the second gear 156, the output torque on the coupler gear 174 via the second gear 156 is greater than an input torque on the first gear 154 via the shaft gear 138. As such, the output torque on the operating nut 30 of the valve 30 is greater than the torque applied by a user turning the operating member 108 of the indicator post 100. In some embodiments, the output torque on the operating nut 30 of the valve 30 may be greater than the input torque on the operating member 108 by a ratio of about at least two to one (2:1).

Table 1 below illustrates the torque required to open/close various large gate valves using an indicator post 100 according to embodiments of the present invention versus a conventional indicator post.

TABLE 1

| | Input Torque Required Using | Input Torque Required Using |
|---|---|---|
| Valve Size | Indicator Post 100 | Conventional Indicator Post |
| 14″ | 150 ft.lbs. | 300 ft.lbs. |
| 16″ | 165 ft.lbs. | 330 ft.lbs. |
| 18″ | 195 ft.lbs. | 390 ft.lbs. |
| 20″ | 215 ft.lbs. | 430 ft.lbs. |
| 24″ | 250 ft.lbs. | 500 ft.lbs. |

As illustrated in Table 1, the input torque required to open and close large gate valves using the indicator post 100 of the present invention is substantially reduced. The input torque required to open and close a 14″ gate valve is about 150 ft·lbs.; the input torque required to open and close a 16″ gate valve is about 165 ft·lbs.; the input torque required to open and close an 18″ gate valve is about 195 ft·lbs.; the input torque required to open and close a 20″ gate valve is about 215 ft·lbs.; and the input torque required to open and close a 24″ gate valve is about 250 ft·lbs.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

That which is claimed is:

1. An indicator post for operating a valve stem of a valve and for indicating a position of the valve, the indicator post comprising:
an elongated housing having opposite first and second ends;
an operating member located at the housing first end, wherein the operating member is rotatable in relation to the housing;
a stem located within the housing and comprising a first end connected to the operating member and an opposite second end;
a coupler configured to rotate the valve stem; and
a gear set positioned at the housing second end, wherein the gear set comprises a plurality of gears arranged to produce an output torque on the coupler that is greater than an input torque from the stem.

2. The indicator post of claim 1, comprising a cap secured to and covering the housing first end, and wherein the operating member extends through the cap.

3. The indicator post of claim 1, further comprising a gear housing configured to be secured to a valve body, wherein the gear housing is located at the housing second end, and wherein the gear set is located within the gear housing.

4. The indicator post of claim 1, wherein the plurality of gears comprises:
a spindle rotatable about a spindle axis;
first and second gears fixed for rotation with the spindle in adjacent, spaced-apart relationship;
a third gear fixed for rotation with the stem, wherein the first gear is operable to mesh with the third gear; and
a fourth gear fixed for rotation with the coupler, wherein the second gear is operable to mesh with the fourth gear.

5. The indicator post of claim 4, wherein the first gear has a diameter that is greater than a diameter of the second gear.

6. The indicator post of claim 1, wherein the output torque is greater than the input torque by a ratio of at least about two to one (2:1).

7. The indicator post of claim 4, wherein the third gear is fixed for rotation with the stem adjacent the stem second end.

8. The indicator post of claim 1, wherein the housing is substantially cylindrical.

9. The indicator post of claim 1, wherein the housing comprises a window that provides an exterior view into the housing, and further comprising an indicator assembly located within the housing and having targets indicative of at least one operating position of the valve, wherein the indicator assembly is connected to the stem so as to be movable relative to the window, and wherein one of the targets is visible through the window while viewing of the other target is obstructed.

10. The indicator post of claim 1, further comprising an operating wrench for rotating the operating member.

11. An indicator post for operating a valve stem of a valve and for indicating a position of the valve, the indicator post comprising:
an elongated housing having opposite first and second ends;
a cap secured to and covering the housing first end;
a gear housing located at the housing second end, wherein the gear housing is configured to be secured to a valve body;
an operating member extending through the cap, wherein the operating member is rotatable in relation to the housing;
a stem located within the housing and comprising a first end connected to the operating member and an opposite second end;
a coupler configured to rotate the valve stem; and
a gear set located within the gear housing, wherein the gear set comprises a plurality of gears arranged to produce an output torque on the coupler that is greater than an input torque from the stem.

12. The indicator post of claim 11, wherein the plurality of gears comprises:
a spindle rotatable about a spindle axis;
first and second gears fixed for rotation with the spindle in adjacent, spaced-apart relationship;
a third gear fixed for rotation with the stem, wherein the first gear is operable to mesh with the third gear; and
a fourth gear fixed for rotation with the coupler, wherein the second gear is operable to mesh with the fourth gear.

13. The indicator post of claim 12, wherein the first gear has a diameter that is greater than a diameter of the second gear.

14. The indicator post of claim 11, wherein the output torque is greater than the input torque by a ratio of at least about two to one (2:1).

15. The indicator post of claim 12, wherein the third gear is fixed for rotation with the stem adjacent the stem second end.

16. The indicator post of claim 11, wherein the housing is substantially cylindrical.

17. The indicator post of claim 11, wherein the housing comprises a window that provides an exterior view into the housing, and further comprising an indicator assembly located within the housing and having targets indicative of at least one operating position of the valve, wherein the indicator assembly is connected to the stem so as to be movable relative to the window, and wherein one of the targets is visible through the window while viewing of the other target is obstructed.

18. An indicator post for operating a valve stem of a valve and for indicating a position of the valve, the indicator post comprising:
an elongated housing having opposite first and second ends;
a cap secured to and covering the housing first end;
a gear housing located at the housing second end, wherein the gear housing is configured to be secured to a valve body;
an operating member extending through the cap, wherein the operating member is rotatable in relation to the housing;
a stem located within the housing and comprising a first end connected to the operating member and an opposite second end;
a coupler configured to rotate the valve stem; and
a gear set located within the gear housing, wherein the gear set comprises a plurality of gears arranged to produce an output torque on the coupler that is greater than an input torque from the stem by a ratio of at least about two to one (2:1), and wherein the plurality of gears comprises:
a spindle rotatable about a spindle axis;
first and second gears fixed for rotation with the spindle in adjacent, spaced-apart relationship;
a third gear fixed for rotation with the stem, wherein the first gear meshes with the third gear; and
a fourth gear fixed for rotation with the coupler, wherein the second gear meshes with the fourth gear.

19. The indicator post of claim 18, wherein the first gear has a diameter that is greater than a diameter of the second gear, and wherein the third gear is fixed for rotation with the stem adjacent the stem second end.

20. The indicator post of claim 18, wherein the housing comprises a window that provides an exterior view into the housing, and further comprising an indicator assembly located within the housing and having targets indicative of at least one operating position of the valve, wherein the indicator assembly is connected to the stem so as to be movable relative to the window, and wherein one of the targets is visible through the window while viewing of the other target is obstructed.
